(19) United States
(12) Patent Application Publication
(10) Pub. No.: US 2008/0252476 A1
(43) Pub. Date: Oct. 16, 2008

(54) CLOSEABLE COMMUNICATIONS DEVICE AND METHOD FOR AUTOMATICALLY OPENING SUCH A DEVICE

(75) Inventor: STEVEN JOHN COSGROVE, SINGAPORE (SG)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/734,344

(22) Filed: Apr. 12, 2007

(51) Int. Cl. G08B 1/00

(52) U.S. Cl. 340/691.7; 455/575.1

(57) ABSTRACT

A method (1000) for automatically opening a closeable communications device and a closeable communications device (100). The closeable communications device (100) has a housing having two biased housing portions (210,220) movably mounted to each other to allow relative movement of the two portions between a closed position and an opened position, the two biased housing portions (210,220) being biased to the opened position. There is an electrically operable latch (270) retaining the two biased housing portions (210,220) in the closed position and a radio frequency communications unit (102) is located in the housing. A processor (103) is located in the housing and is coupled to both the radio frequency communications unit (102) and the electrically operable latch (270). In use, when the radio frequency communications unit (102) receives an incoming call and the housing is in the closed position, the processor (103) provides a control signal to release the retaining by the electrically operable latch (270) thereby allowing the biased housing portions to move automatically to the opened position.

### FIELD OF THE INVENTION

The present invention relates generally to automatically opening a closeable communications device in response to an incoming call. The invention is particularly useful for, but not necessarily limited to, automatically opening communications devices, typically cellular telephones, having two part housings such as clamshell telephones, flip phones, and other multi part housing telephones that are movable from a closed position to an opened position.

### BACKGROUND

Portable communications devices such as cellular telephones are becoming commonplace in society. With increasing use of such devices there has been a demand for increased functionality and greater compactness for ease and convenience of use. Customarily, these portable communications devices accompany users most of the time and recently there has been a trend towards flip phones, and other multi part housing telephones that are movable from a closed position to an opened position and vice versa. Such multi part or multi portion housing telephones typically provide greater compactness and may provide for ease of use for functions such as video conferencing and picture taking.

When closeable multi part (multi portion) housing telephones are in a closed position and they receive an incoming call, the user is typically required to manually move the telephone's housing from a closed position to an opened position before the call can be answered. It is therefore desirable to provide a multi part (multi portion) housing telephone that automatically moves from a closed position to an opened position upon receiving an incoming call.

### BRIEF DESCRIPTION OF THE FIGURES

In order that the invention may be readily understood and put into practical effect, reference will now be made to an exemplary embodiments as illustrated with reference to the accompanying figures, where like reference numerals refer to identical or functionally similar elements throughout the separate views. The figures together with a detailed description below, are incorporated in and form part of the specification, and serve to further illustrate the embodiments and explain various principles and advantages, in accordance with the present invention where:

FIG. 1 is a block diagram of a closeable communications device in accordance with the present invention;

FIG. 2 illustrates an embodiment of the closeable communications device in the form of a two part housing slider telephone when in a closed position in accordance with the present invention;

FIG. 3 illustrates the two part housing slider telephone of FIG. 2 when in an opened position;

FIG. 4 is a cross section view through 4-4′ of FIG. 2;

FIG. 5 is a cross section view through 5-5′ of FIG. 3;

FIG. 6 illustrates another embodiment of the closeable communications device in the form of a two part housing clamshell telephone when in a closed position in accordance with the present invention;

FIG. 7 illustrates the two part housing clamshell telephone of FIG. 6 when in an opened position;

FIG. 8 is a cross section view through 8-8′ of FIG. 6 when in a latched position;

FIG. 9 is a cross section view through 8-8′ of FIG. 6 when in a unlatched position; and

FIG. 10 is a flow diagram illustrating a method for automatically opening the closeable radio communications device of FIG. 1.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of device components and method steps. The device components and method steps have been represented by showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a method or device that comprises a list of elements does not include only those elements but may include other elements not expressly listed or inherent to such method or device. An element proceeded by “comprises . . . a” does not, without more constraints, preclude the existence of additional identical elements in the method or device that comprises the element.

According to one aspect of the present invention there is provided a closeable communications device comprising housing having two biased housing portions movably mounted to each other to allow relative movement of the two portions between a closed position and an opened position, the two biased housing portions being biased to the opened position. There is an electrically operable latch retaining the two biased housing portions in the closed position and a radio frequency communications unit is located in the housing. A processor is located in the housing and is coupled to both the radio frequency communications unit and the electrically operable latch. In use, when the radio frequency communications unit receives an incoming call and the housing is in the closed position, the processor provides a control signal to release the retaining by the electrically operable latch thereby allowing the biased housing portions to move automatically to the opened position.

According to another aspect of the present invention there is provided a method for automatically opening a closeable radio communications device. The method performs detecting an incoming call; and then providing, in response to the detecting, a control signal to release an electrically operable latch retaining at least two biased housing portions of a housing of the closeable radio communications device in a closed position.

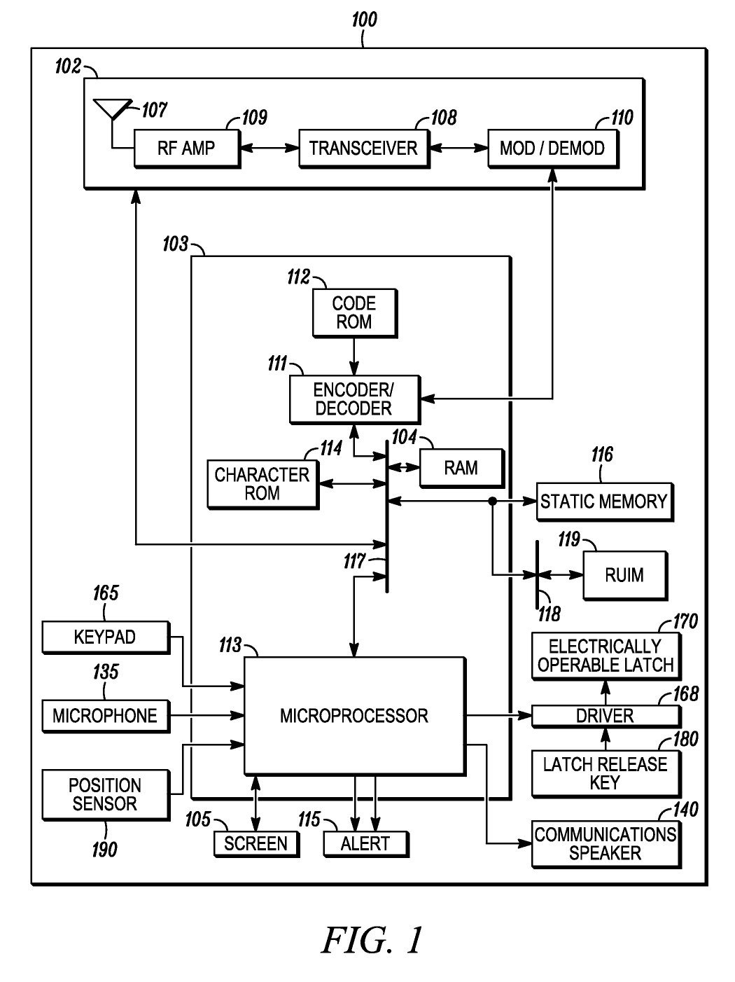

Referring to FIG. 1, there is a schematic diagram illustrating a closeable communications device 100 the form of a two part radio telephone or cellular telephone comprising a radio frequency communications unit 102 coupled to be in communication with a processor 103. The closeable communications device 100 also has a screen 105 and a keypad 165. There is also an alert module 115 that typically contains an alert speaker, vibrator motor and associated drivers. The screen 105, keypad 165 and alert module 115 are coupled to be in communication with the processor 103.

The processor 103 includes an encoder/decoder 111 with an associated code Read Only Memory (ROM) 112 for storing data for encoding and decoding voice or other signals that may be transmitted or received by the closeable communications device 100. The processor 103 also includes a micro-processor 113 coupled, by a common data, control and address bus 117, to the radio frequency communications unit 102, the encoder/decoder 111, a character Read Only Memory (ROM) 114, a Random Access Memory (RAM) 104, a static programmable memory 116 and a Removable User Identity Module (RUIM) interface 118. The static programmable memory 116 and a RUIM card 119 (commonly referred to as a Subscriber Identity Module (SIM) card), operatively coupled to the RUIM interface 118, each can store amongst other things, Preferred Roaming Lists (PRLs), subscriber authentication data, selected incoming text messages and a Telephone Number Database (TND phonebook) comprising a number field for telephone numbers and a name field for identifiers associated with one of the numbers in the name field. The RUIM card 119 and static programmable memory 116 may also store passwords for allowing accessibility to password-protected functions on the closeable communications device 100.

The micro-processor 113 has ports for coupling to the screen 105, the auxiliary keys and the alert module 115. Also, micro-processor 113 has ports for coupling to a microphone 135, a communications speaker 140 and an input of a driver 168 that has an output coupled to a electrically operable latch 170. Thus, the electrically operable latch 170 is coupled to the processor 103 through the driver. Further, there is a dedicated latch release key 180 coupled to an input of the driver and a position sensor 190, typically a Hall Effect sensor, is coupled to a port of the microprocessor 113. The position sensor 190 is well known in the art and provides a position signal indicative of when the closeable communications device 100 is in the opened position or closed position.

The character Read Only Memory 114 stores code for decoding or encoding text messages that may be received by the communications unit 102. In this embodiment the character Read Only Memory 114, RUIM card 119, and static programmable memory 116 may also store Operating Code (OC) for the micro-processor 113 and code for performing functions associated with the closeable communications device 100.

The radio frequency communications unit 102 is a combined receiver and transmitter having a common antenna 107. The communications unit 102 has a transceiver 108 coupled to the common antenna 107 via a radio frequency amplifier 109. It should be noted that although one typical example of the radio frequency communications unit 102 is illustrated and described, there are many other forms of radio frequency communications unit 102 that can be used in the present invention. Also, as illustrated, the transceiver 108 is coupled to a combined modulator/demodulator 110 that couples the communications unit 102 to the encoder/decoder 111 of processor 103.

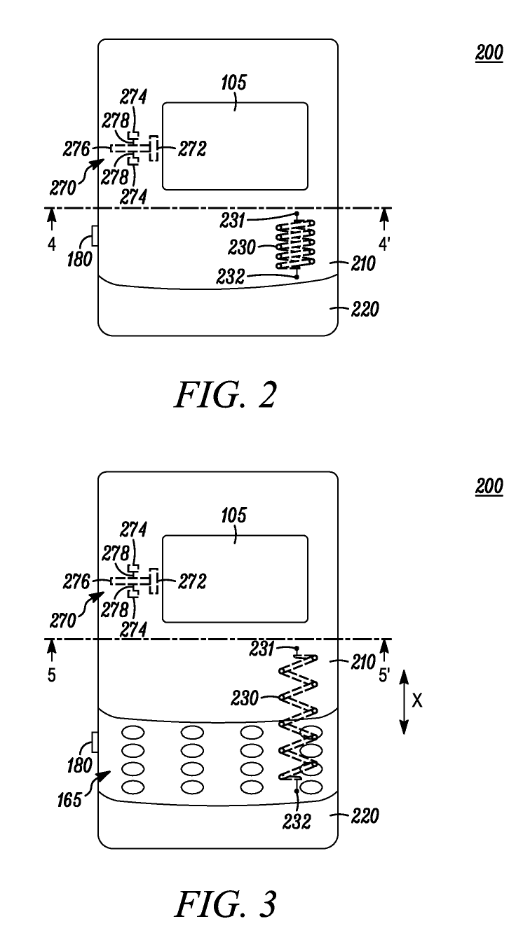

Referring to FIG. 2 there is illustrated a plan view of one embodiment of the closeable communications device 100 in the form of a two part housing slider telephone 200 when in a closed position. The two part housing slider telephone 200 includes one embodiment of the electrically operable latch 170 in the form of a pivotal solenoid assembly 270.

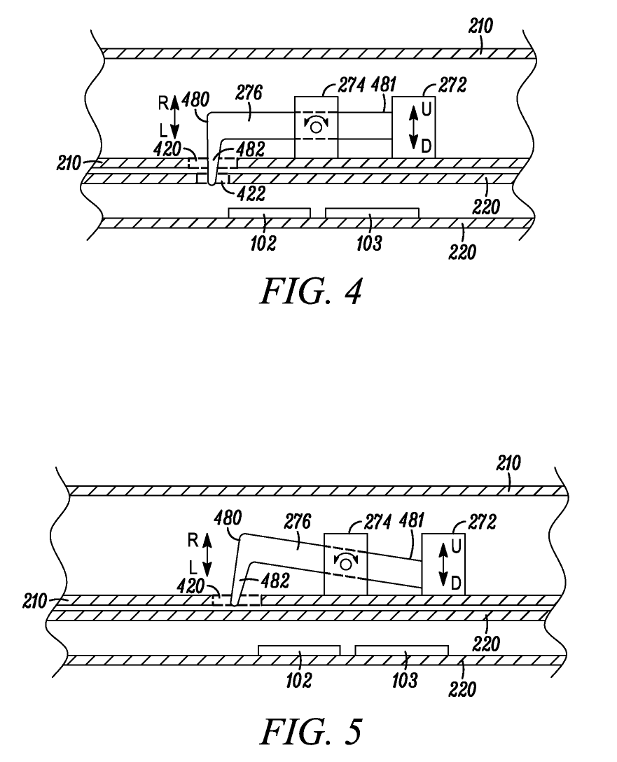

In FIG. 3 there is illustrated a plan view of the two part housing slider telephone 200 when in an opened position. In FIG. 4 a cross section view through 4-4′ of FIG. 2 is illustrated and in FIG. 5 a cross section view through 5-5′ of FIG. 3 is illustrated. Referring to FIGS. 2-5, the two part housing slider telephone 200 has a housing comprising two biased portions 210 and 220 biased by a compression spring 230 with one end 231 attached to the housing portion 210 and the other end 231 attached to the biased housing portion 220. The two biased portions 210,220 are movably mounted to each other to allow relative movement of the two biased portions 210,220 between a closed position and an opened position, the two portions being biased to the opened position. The processor 103 and radio frequency communications unit 102 plus most of the other components and units of the closeable communications device 100 are located in the housing comprising the two biased portions 210, 220. In FIGS. 2 and 4 the pivotal solenoid assembly 270 is in a latched position retaining the two biased portions 210,220 of the two part housing slider telephone 200 is in the closed position, whereas in FIGS. 3 and 5 the pivotal solenoid assembly 270 is in an unlatched position and therefore the two part housing slider telephone 200 is in the opened position.

The pivotal solenoid assembly 270 comprises a solenoid coil 272, two pivot mounts 274 and an iron rocker latch arm 276 pivotally mounted by a pin 278 to the pivot mounts 274. Extending from a free end 480 of the iron rocker latch arm 276 is a latch finger 482 that extends, when the closeable communications device 100 is in the closed position, into aligned apertures 420, 422 in which aperture 420 is in the biased housing portion 210 and aperture 422 is in the biased housing portion 220. In operation, when the pivotal solenoid assembly 270 is in the latched position and the processor 103 provides a control signal to release the electrically operable latch in the form of the pivotal solenoid assembly 270, the driver 168 provides electrical power to energize the solenoid coil 272 for approximately one second. As a result, a solenoid end 481 of the iron rocker latch arm 276 moves in a direction indicated by arrow D and the latch finger 482 moves out of the aperture 422 in a direction indicated by arrow R. Accordingly, the pivotal solenoid assembly 270 moves from the latched position to an unlatched position and the biasing of the compression spring automatically opens the biased housing portions 210,220 that move relative to each other in a sliding relationship as indicated by arrows X.

When unlatched, and the solenoid coil is de-energized the pivotal solenoid assembly 270 remains unlatched since the apertures 420,430 are misaligned and thus the latch finger 482 cannot interlock with both the apertures 420,430. However, when the two biased housing portions 210,220 are manually moved back to the closed position, the apertures 420,430 again become aligned and solenoid end 481 (biased by a spring in the solenoid coil 272) is urged in a direction of arrow U and thus the latch finger 482 moves in a direction of arrow L into the apertures 420,430 to form an interlocking engagement thereby latching the two part housing slider telephone 200 in the closed position.

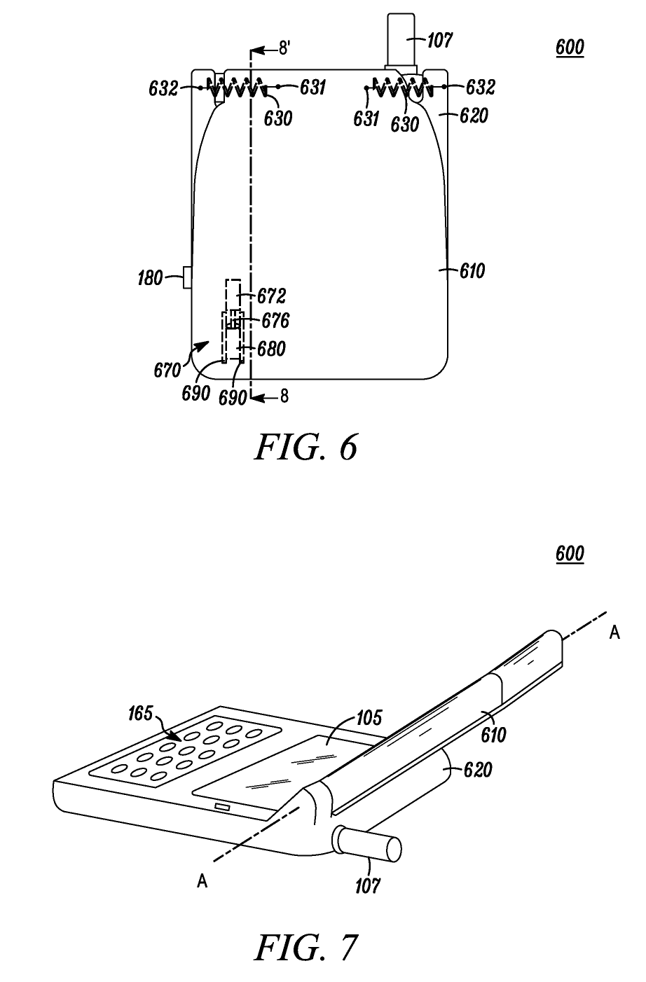

Referring to FIG. 6 there is illustrated a plan view of another embodiment of the closeable communications device 100 in the form of a two part housing clamshell telephone 600 when in a closed position. The two part housing clamshell telephone 600 includes another embodiment of the electrically operable latch 170 in the form of a solenoid and permanent magnet assembly 670.

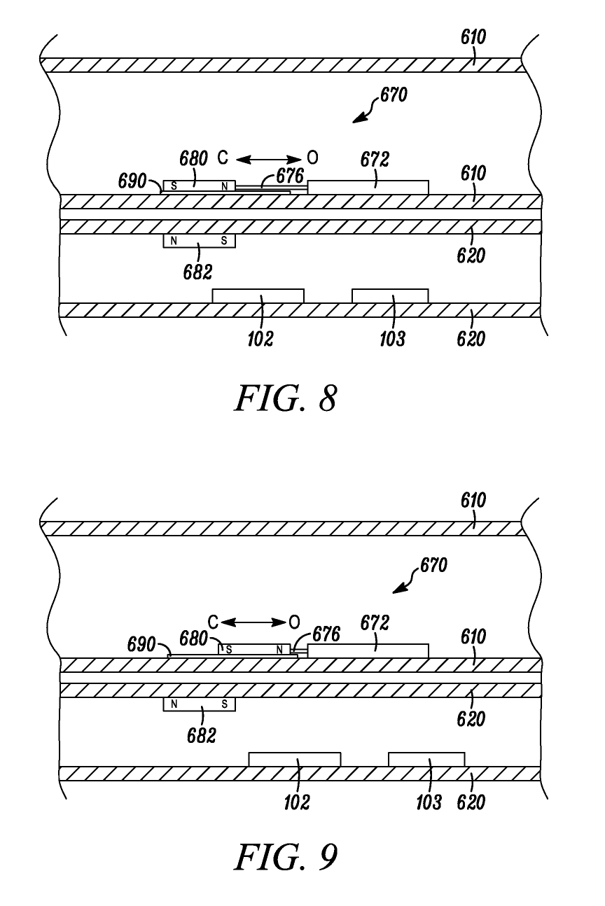

In FIG. 7 there is illustrated a perspective view of the two part housing clamshell telephone 600 when in an opened position. In FIG. 8 a cross section view through 8-8′ of FIG. 6 when the solenoid and permanent magnet assembly 670 are in a latched position is illustrated and in FIG. 9 a cross section view through 8-8′ of FIG. 6 when the solenoid and permanent magnet assembly 670 are in an unlatched position is illustrated. Referring to FIGS. 6-9, the two part housing clamshell telephone 600 has a housing comprising two biased portions 610 and 620 biased by two springs 630 with one of their respective ends 631 attached to the biased housing portion 610 and the other of their respective ends 631 attached to the biased housing portion 620. The two biased portions 610,620 are movably mounted to each other to allow relative movement of the two portions between a closed position and an opened position, the two biased portions 610, 620 being biased to the opened position. The processor 103 and radio frequency communications unit 102 plus most of the other components and units of the closeable communications device 100 are located in the housing comprising the two biased portions 610, 620. In FIGS. 6 and 8 the solenoid and permanent magnet assembly 670 is in a latched position retaining the two biased portions 610,620 of the two part housing slider telephone 200 is in the closed position, whereas in FIGS. 7 and 9 the solenoid and permanent magnet assembly 670 is in an unlatched position.

The solenoid and permanent magnet assembly 670 comprises a solenoid coil 672, an iron slider arm 676 protruding at one end into the solenoid coil 672 and the other end being coupled to a slidable permanent magnet 680. The slidable permanent magnet 680 is mounted to and disposed in the in the biased housing portion 610, more specifically the slidable permanent magnet 680 is slidably mounted in and retained in guide tracks 690. When the closeable communications device 100 is in the closed position, the slidable permanent magnet 680 is aligned with a fixed permanent magnet 682 that is mounted to and disposed in the biased housing portion 620. When so aligned, the magnets 680, 683 are interacting in which opposite poles of the magnets 680,682 are aligned and therefore provide a magnetic latch maintaining the biased housing portions 610,620 in the closed position (latched position).

In operation, when the solenoid and permanent magnet assembly 670 is in the latched position and the processor 103 provides a control signal to release the electrically operable latch in the form of the solenoid and permanent magnet assembly 670, the driver 168 provides electrical power to energize the solenoid coil 672 for approximately one second. As a result, the iron slider arm 676 is pulled into the solenoid coil 672 in a direction indicated by arrow O and thus the slidable permanent magnet 680 moves, guided by the guide tracks 680, towards the solenoid coil 672 and out of alignment with the fixed permanent magnet 682 such that an identical pole of each of the magnets 680,682 are aligned (as illustrated the south poles are aligned). Accordingly, the solenoid and permanent magnet assembly 670 moves from the latched position to an unlatched position and the biasing of the springs 630 assisted by the repelling magnetic forces of the aligned identical poles of the magnets 680, 682 automatically opens the biased housing portions 610,620 that move relative to each other about a pivotal axis A.

When the solenoid coil is de-energized (after approximately one second) a compression spring inside the solenoid coil 672 urges most of the iron slider arm 676 out of the solenoid coil 672. As a result, the slidable permanent magnet 680 is moved in a direction indicated by arrow C so that the slidable permanent magnet 680 will be in alignment with the fixed permanent magnet 682 when the biased housing portions 610,620 are manually moved to the closed position,

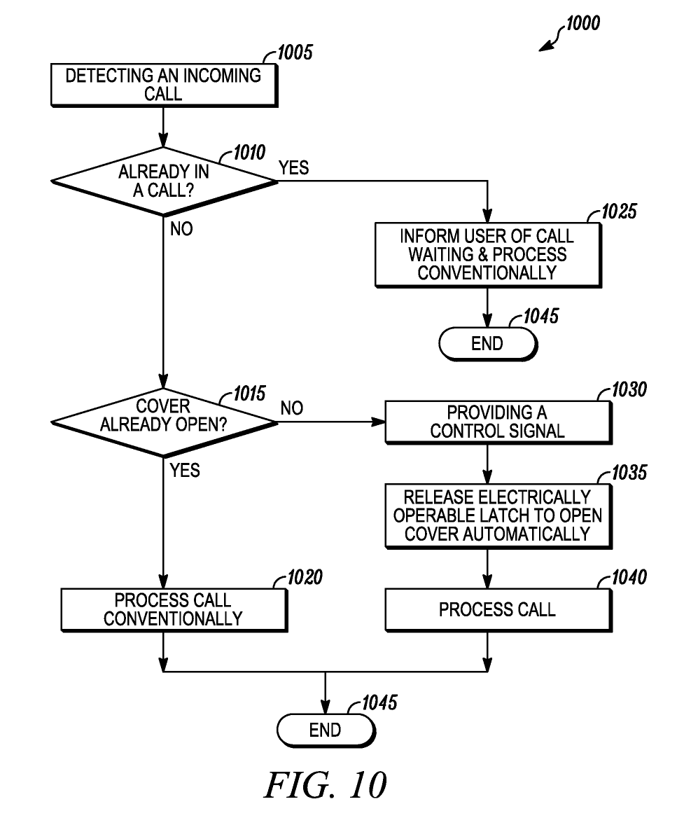

Referring to FIG. 10 there is illustrated a flow diagram illustrating a method 1000 for automatically opening the closeable communications device 100. At a block 1005 the method 1000 is initiated upon the closeable communications device 100 detecting an incoming call that is received by the radio frequency communications unit 102. At a test block 1010 the method 1000 determines if the closeable communications device 100 is already in a call. If the closeable communications device 100 is already in a call then at block 1025 the user is informed of the incoming call by a call waiting signal and the call is processed conventionally, the method 1000 then ends at a block 1045.

If at test block 1010 the method 1000 determines if the closeable communications device 100 is not already in a call then a test, at a test block 1015, is conducted to determine if the closeable communications device 100, for example the biased housing portions 210,220 of the two part housing slider telephone 200, are already in the opened position “COVER ALREADY OPEN?”. If the position sensor 190 provides a signal to the microprocessor 113 such that it is determined that the biased housing portions 210,220 of the two part housing slider telephone 200 are already in the opened position, then the method 1000 at a block 1020 processes the call conventionally and then the method 1000 ends at block 1045. However, if at test block 1015, the position sensor 190 provides a signal to the microprocessor 113 such that it is determined that the biased housing portions 210, 220 are in the closed position, then the processor 103 provides, in response to the detecting the incoming call at block 1005, a control signal at a block 1030 to release the electrically operable latch 170. Thus, at a block 1035 the control signal invokes the driver 168 to energize solenoid coil 272 or 672 thereby releasing the electrically operable latch 170 in the form of the pivotal solenoid assembly 270 or permanent magnet assembly 670 and allowing the biased housing portions 210,220 (or biased housing portions 610,620 when considering the two part housing clamshell telephone 600) to move automatically to the opened position “OPEN COVER AUTOMATICALLY”. The call is then processed conventionally at a block 1040 and the call terminates at block 1045.

From the above it will be appreciated that in use when the radio frequency communications unit 102 receives an incoming call and the housing, comprising for example biased housing portions 210, 220, is in the closed position, the processor 103 provides a control signal to release the retaining by the electrically operable latch 107 thereby allowing the biased housing portions to move automatically to the opened position. Thus, advantageously, the present invention provides for automatically opening the biased housing portions 210, 220 (or portions 610,620) comprising the housing of the closeable communications device 100. Thus, the closeable communications device 100 opens automatically upon receiving an incoming call and a user can then actuate the keypad to answer the call or alternatively the call can be automatically answered when the closeable communications device 100 is automatically opened. Thus, the present invention alleviates the need requirement for a user to manually move the telephone's housing from a closed position to an opened position before the call can be answered.

It should also be noted that the automatically opening the biased housing portions 210, 220 (or portions 610,620) upon receiving an incoming call can act as an alert indicating that there is an incoming call when for example the alert module is in silent mode. Also, if a user wishes to open the biased housing portions 210, 220, to for example make a telephone call, then the user simply actuates the dedicated latch release key 180 that operates the electrically operable latch 170.

It will be appreciated that the embodiment of the present invention described herein may be comprised of one or more conventional processors and unique stored program instructions that control the one or more processors to implement, in conjunction with certain non-processor circuits, some, most, or all of the functions for automatically opening the device as described herein. The non-processor circuits may include, but are not limited to, a radio receiver, a radio transmitter, signal drivers, clock circuits, power source circuits, and user input devices. As such, these functions may be interpreted as steps of the method for automatically opening the device. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, specific embodiments of the present invention have been described. However, one of ordinary skill in the art appreciates that various modifications and changes can be made without departing from the scope of the present invention as set forth in the claims below. For example, other variations of solenoids, electro mechanical latch mechanism and permanent magnet arrangements can be used to implement the electrically operable latch 170. Also, other forms of closeable communications devices can be used such as rotatable housings cellular telephones similar to the Motorola V70™ and V80™ models. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims.

We claim:

1. A closeable communications device comprising:
a housing having at least two biased housing portions movably mounted to each other to allow relative movement of the two portions between a closed position and an opened position, the two biased housing portions being biased to the opened position;
an electrically operable latch retaining the two biased housing portions in the closed position;
a radio frequency communications unit located in the housing; and
a processor located in the housing and coupled to the radio frequency communications unit and the electrically operable latch, wherein in use, when the radio frequency communications unit receives an incoming call and the housing is in the closed position, the processor provides a control signal to release the retaining by the electrically operable latch thereby allowing the biased housing portions to move automatically to the opened position.

2. A closeable radio communications device as claimed in claim 1, wherein the electrically operable latch includes a solenoid.

3. A closeable radio communications device as claimed in claim 1, wherein the radio frequency communications unit comprises a transceiver.

4. A closeable radio communications device as claimed in claim 1, wherein the electrically operable latch comprises interacting magnets mounted to respective ones of the biased portions.

5. A closeable radio communications device as claimed in claim 4, wherein the interacting magnets are disposed in the respective ones of the biased housing portions.

6. A closeable radio communications device as claimed in claim 4, wherein one of the magnets is slidably mounted to one of the biased housing portions.

7. A closeable radio communications device as claimed in claim 1, wherein the electrically operable latch comprises a pivotal solenoid assembly.

8. A closeable radio communications device as claimed in claim 7, wherein when the housing is in the closed position, a latch finger of the pivotal solenoid assembly extends into aligned apertures in each of the biased housing portions.

9. A method for automatically opening a closeable radio communications device, the method comprising:
detecting an incoming call; and
providing, in response to the detecting, a control signal to release an electrically operable latch retaining at least two biased housing portions of a housing of the closeable radio communications device in a closed position.

10. A method for automatically opening a closeable radio communications device, as claimed in claim 9, wherein the incoming call is automatically answered after the providing.

11. A method for automatically opening a closeable radio communications device, as claimed in claim 9, wherein the electrically operable latch includes a solenoid.

12. A method for automatically opening a closeable radio communications device, as claimed in claim 9, wherein the electrically operable latch comprises interacting magnets mounted to respective ones of the biased portions.

13. A method for automatically opening a closeable radio communications device, as claimed in claim 12, wherein the interacting magnets are disposed in the respective ones of the biased housing portions.

14. A method for automatically opening a closeable radio communications device, as claimed in claim 12, wherein one of the magnets is slidably mounted to one of the biased housing portions.

15. A method for automatically opening a closeable radio communications device, as claimed in claim 9, wherein the electrically operable latch comprises a pivotal solenoid assembly.

16. A method for automatically opening a closeable radio communications device, as claimed in claim 15, wherein when the housing is in the closed position, a latch finger of the pivotal solenoid assembly extends into aligned apertures in each of the biased housing portions.
